(19) United States
(12) Patent Application Publication
(10) Pub. No.: US 2019/0056048 A1
(43) Pub. Date: Feb. 21, 2019

(54) LAMINATE, MOLDED ARTICLE, AND IN-TANK TUBE

(71) Applicant: DAIKIN INDUSTRIES, LTD., Osaka (JP)

(72) Inventors: Yuuki KUWAJIMA, Osaka (JP); Takeshi INABA, Osaka (JP)

(73) Assignee: DAIKIN INDUSTRIES, LTD., Osaka (JP)

(21) Appl. No.: 16/100,307

(22) Filed: Aug. 10, 2018

(30) Foreign Application Priority Data
Aug. 21, 2017 (JP) 2017-158843

(51) Int. Cl. F16L 11/15; F16L 11/11; F02M 37/00; F02M 37/10; B29C 47/00; B32B 1/08; B32B 27/34

(52) U.S. Cl. CPC F16L 11/15; F16L 11/111; F02M 37/0076; B29L 2023/22; B29C 47/0023; B32B 1/08; B32B 27/34; F02M 37/106

(57) ABSTRACT

The invention provides a laminate having high elastic modulus retention even at high temperature and having moderate hardness. The laminate includes a layer (A) formed from a fluororesin and a layer (B) formed from a polyamide resin. The fluororesin is a copolymer containing a copolymerized unit of tetrafluoroethylene and a copolymerized unit of vinylidene fluoride, and has a storage elastic modulus (E′) of 60 to 400 MPa measured by dynamic mechanical analysis at 170° C.

### TECHNICAL FIELD

The invention relates to laminates, molded articles, and in-tank tubes.

### BACKGROUND ART

Common fuel piping systems of automobiles have a mechanism in which fuel required to start an engine is sucked and supplied from a fuel tank, and such suction of fuel is performed by a pump disposed inside the fuel tank. The hose coupled with this fuel pump in the fuel tank is referred to as an in-tank tube.

For example, Patent Literature 1 discloses an in-tank tube for automobile fuel having a monolayer structure formed from a resin material that mainly contains an aliphatic polyamide resin and exhibiting predetermined pressure-resistant performance.

### CITATION LIST

### Patent Literature

### Patent Literature 1: WO 2011/114865

### SUMMARY OF INVENTION

### Technical Problem

In systems such as fuel piping systems of automobiles, parts used for pipes and other components are exposed to high temperature. Thus, for the use as an in-tank tube, a laminate having high elastic modulus retention even at high temperature and having moderate hardness is desired. Yet, the in-tank tube disclosed in Patent Literature 1 is still insufficient in elastic modulus retention at high temperature.

The invention provides a laminate having high elastic modulus retention even at high temperature and having moderate hardness. The invention also provides an in-tank tube having high elastic modulus retention even at high temperature and having moderate hardness.

### Solution to Problem

The invention relates to a laminate including a layer (A) formed from a fluororesin and a layer (B) formed from a polyamide resin, the fluororesin being a copolymer containing a copolymerized unit of tetrafluoroethylene and a copolymerized unit of vinylidene fluoride, and having a storage elastic modulus (E′) of 60 to 400 MPa measured by dynamic mechanical analysis at 170° C.

The polyamide resin preferably has a melting point of 200° C. or higher.

The invention also relates to a molded article formed from the laminate. The invention also relates to an in-tank tube formed from the laminate (hereinafter, also referred to as a “first in-tank tube of the invention”). The in-tank tube is preferably intended to be disposed inside a fuel tank.

The invention also relates to an in-tank tube including a layer (A′) formed from a fluororesin, the fluororesin being a copolymer containing a polymerized unit based on tetrafluoroethylene and a polymerized unit based on vinylidene fluoride, and having a storage elastic modulus (E′) of 60 to 400 MPa measured by dynamic mechanical analysis at 170° C. (hereinafter, also referred to as a “second in-tank tube of the invention”). The in-tank tube is preferably intended to be disposed inside a fuel tank.

The second in-tank tube of the invention also preferably consists only of the layer (A′) formed from a fluororesin. The in-tank tube is preferably intended to be disposed inside a fuel tank.

The fluororesin preferably has a tensile modulus at 150° C. that corresponds to 15% or more of the tensile modulus at room temperature.

In the laminate and in-tank tubes of the invention, the fluororesin is preferably a copolymer containing a copolymerized unit of tetrafluoroethylene, a copolymerized unit of vinylidene fluoride, and a copolymerized unit of an ethylenically unsaturated monomer represented by the formula (1), excluding tetrafluoroethylene and vinylidene fluoride, and/or a copolymerized unit of an ethylenically unsaturated monomer represented by the formula (2),

the formula (1) being CX¹X²═CX³(CF₂)ₙX⁴

wherein X¹, X², X³, and X⁴ are the same as or different from each other, and are each H, F, or Cl; and n is an integer of 0 to 8,

the formula (2) being CF₂═CF—ORf¹

wherein Rf¹ is a C1-C3 alkyl or fluoroalkyl group.

### Advantageous Effects of the Invention

The laminate of the invention includes a fluororesin layer formed from a specific fluororesin and a polyamide resin layer, and thus has high elastic modulus retention even at high temperature and has moderate hardness. The first in-tank tube of the invention formed from the laminate, which includes a fluororesin layer formed from a specific fluororesin and a polyamide resin layer, has high elastic modulus retention even at high temperature and has moderate hardness.

The second in-tank tube of the invention, which includes a fluororesin layer formed from a specific fluororesin, can have high elastic modulus retention even at high temperature and have moderate hardness.

### BRIEF DESCRIPTION OF THE DRAWINGS

FIG. 1 is a schematic view of the inside of a fuel tank of an automobile.

### DESCRIPTION OF EMBODIMENTS

### (A) Fluororesin Layer

The layer (A) is formed from a fluororesin. The fluororesin is a copolymer containing a copolymerized unit of tetrafluoroethylene and a copolymerized unit of vinylidene fluoride, and has a storage elastic modulus (E′) of 60 to 400 MPa measured by dynamic mechanical analysis at 170° C.

The fluororesin has a storage elastic modulus (E′) of 60 to 400 MPa measured by dynamic mechanical analysis at 170° C. The storage elastic modulus is a value measured by dynamic mechanical analysis at 170° C. Specifically, it is a value measured using a dynamic viscoelasticity analyzer DVA220 (IT Keisoku Seigyo) and a sample having a size of 30 mm in length, 5 mm in width, and 0.25 mm in thickness in a tensile mode, at a grip width of 20 mm, a measurement temperature of 25° C. to 250° C., a temperature-increasing rate of 2° C./min, and a frequency of 1 Hz. The storage elastic modulus (E′) is preferably 80 to 350 MPa, more preferably 100 to 350 MPa, at 170° C.

The fluororesin is either a copolymer consisting only of a copolymerized unit of tetrafluoroethylene and a copolymerized unit of vinylidene fluoride, or a copolymer containing a copolymerized unit of tetrafluoroethylene, a copolymerized unit of vinylidene fluoride, and a copolymerized unit of an ethylenically unsaturated monomer excluding tetrafluoroethylene and vinylidene fluoride.

The ethylenically unsaturated monomer may be any monomer copolymerizable with tetrafluoroethylene and vinylidene fluoride, and is preferably at least one selected from the group consisting of ethylenically unsaturated monomers represented by the following formula (1), excluding tetrafluoroethylene and vinylidene fluoride, and ethylenically unsaturated monomers represented by the following formula (2).

CX¹X²═CX³(CF₂)ₙX⁴ Formula (1):

In the formula (1), X¹, X², X³, and X⁴ are the same as or different from each other, and are each H, F, or Cl; and n is an integer of 0 to 8.

CF₂═CF—ORf¹ Formula (2):

In the formula (2), Rf¹ is a C1-C3 alkyl or fluoroalkyl group.

Preferred among the ethylenically unsaturated monomers represented by the formula (1) is at least one selected from the group consisting of CF₂═CFCl, CF₂═CFCF₃, those represented by the following formula (3):

CH₂═CF—(CF₂)ₙX⁴ (3)

(wherein X⁴ and n are defined as mentioned above), and those represented by the following formula (4):

CH₂═CH—(CF₂)ₙX⁴ (4)

(wherein X⁴ and n are defined as mentioned above); and more preferred is at least one selected from the group consisting of CF₂═CFCl, CH₂═CFCF₃, CH₂═CH—C₄F₉, CH₂═CH—C₆F₁₃, CH₂═CF—C₃F₆H, and CF₂═CFCF₃, still more preferred is at least one selected from the group consisting of CF₂═CFCl and CH₂═CFCF₃.

Preferred among the ethylenically unsaturated monomers represented by the formula (2) is at least one selected from the group consisting of CF₂═CF—OCF₃, CF₂═CF—OCF₂CF₃, and CF₂═CF—OCF₂CF₂CF₃.

The fluororesin is preferably a copolymer containing

58.0 to 85.0 mol % of a copolymerized unit of tetrafluoroethylene,

10.0 to 41.9 mol % of a copolymerized unit of vinylidene fluoride, and

0.1 to 5.0 mol % of a copolymerized unit of an ethylenically unsaturated monomer represented by the formula (1), excluding tetrafluoroethylene and vinylidene fluoride:

CX¹X²═CX³(CF₂)ₙX⁴ (1)

wherein X¹, X², X³, and X⁴ are the same as or different from each other, and are each H, F, or Cl; and n is an integer of 0 to 8.

The fluororesin is more preferably a copolymer containing

58.0 to 85.0 mol % of a copolymerized unit of tetrafluoroethylene,

12.0 to 41.9 mol % of a copolymerized unit of vinylidene fluoride, and

0.1 to 3.0 mol % of a copolymerized unit of an ethylenically unsaturated monomer represented by the formula (1).

The fluororesin is also preferably a copolymer containing

55.0 to 90.0 mol % of a copolymerized unit of tetrafluoroethylene,

9.2 to 44.2 mol % of a copolymerized unit of vinylidene fluoride, and

0.1 to 0.8 mol % of a copolymerized unit of an ethylenically unsaturated monomer represented by the following formula (2):

CF₂═CF—ORf¹ (2)

wherein Rf¹ is a C1-C3 alkyl or fluoroalkyl group.

The fluororesin is more preferably a copolymer containing

58.0 to 85.0 mol % of a copolymerized unit of tetrafluoroethylene,

14.5 to 41.9 mol % of a copolymerized unit of vinylidene fluoride, and

0.1 to 0.5 mol % of a copolymerized unit of an ethylenically unsaturated monomer represented by the formula (2).

The fluororesin is also preferably a copolymer containing

55.0 to 90.0 mol % of a copolymerized unit of tetrafluoroethylene,

6.2 to 44.8 mol % of a copolymerized unit of vinylidene fluoride,

0.1 to 3.0 mol % of a copolymerized unit of an ethylenically unsaturated monomer represented by the formula (1), and

0.1 to 0.8 mol % of a copolymerized unit of an ethylenically unsaturated monomer represented by the formula (2).

The fluororesin is more preferably a copolymer containing

58.0 to 85.0 mol % of a copolymerized unit of tetrafluoroethylene,

11.5 to 39.8 mol % of a copolymerized unit of vinylidene fluoride,

0.1 to 3.0 mol % of a copolymerized unit of an ethylenically unsaturated monomer represented by the formula (1), and

0.1 to 0.5 mol % of a copolymerized unit of an ethylenically unsaturated monomer represented by the formula (2).

The fluororesin in which the amounts of the monomers fall within the above respective ranges has higher crystallinity and higher elastic modulus retention even at high temperature than conventionally known copolymers containing tetrafluoroethylene, vinylidene fluoride, and a third component.

Other conventional tetrafluoroethylene-vinylidene fluoride bipolymers free from a third component in which the amount of tetrafluoroethylene is more than 50 mol % provide molded articles with significantly poor crack resistance. In contrast, the copolymer of the invention can also lead to excellent crack resistance.

The amounts of the respective copolymerized units of the copolymer can be calculated by appropriate combination of NMR and elemental analysis in accordance with the types of the monomers.

The fluororesin used in the invention can have high crystallinity as a result of copolymerization of tetrafluoroethylene, vinylidene fluoride, and an ethylenically unsaturated monomer in a specific composition ratio. Thus, the laminate of the invention including a layer (A) formed from this fluororesin has excellent barrier performance and has high elastic modulus retention even at high temperature.

The fluororesin preferably has a tensile modulus at 150° C. that corresponds to 15% or more, more preferably 20% or more, particularly preferably 25% or more, of the tensile modulus at room temperature (25° C.)

The fluororesin also preferably has a tensile modulus at 150° C. that corresponds to 40% or more, more preferably 60% or more, still more preferably 70% or more, particularly preferably 80% or more, of the tensile modulus at 100° C. Such a high tensile modulus retention at high temperature allows the laminate to maintain its hardness even at high temperature, enabling the use thereof without flexure due to vibration, pulsation, internal pressure, and other factors during the use.

The tensile modulus is a value determined using a 2-mm-thick microdumbbell at a tensile rate of 100 mm/min in conformity with ASTM D1708. The resulting value is an average value with N=5.

The above tensile modulus retention is particularly preferred for the use as an in-tank tube.

The fluororesin preferably has a melt flow rate (MFR) of 0.1 to 50 g/10 min.

The MFR refers to the mass (g/10 min) of a polymer flowing out of a nozzle (inner diameter: 2 mm, length: 8 mm) per 10 minutes at 297° C. and a 5-kg load using a melt indexer (Toyo Seiki Seisaku-sho, Ltd.) in conformity with ASTM D3307-01.

The fluororesin preferably has a melting point of 180° C. or higher, and the upper limit thereof may be 290° C. The lower and upper limits thereof are more preferably 200° C. and 270° C., respectively.

The melting point refers to the temperature corresponding to the peak on an endothermic curve obtained by thermal analysis at a temperature-increasing rate of 10° C./min using a differential scanning calorimeter RDC220 (Seiko Instruments Inc.) in conformity with ASTM D-4591.

The fluororesin preferably has a pyrolysis starting temperature of 360° C. or higher. The lower limit thereof is more preferably 370° C. The upper limit of the pyrolysis starting temperature may be 450° C., for example, as long as it falls within the above range.

The pyrolysis starting temperature refers to the temperature at which 1 mass % of a fluororesin subjected to a heating test is decomposed, and is a value obtainable by measuring the temperature at which the mass of the fluororesin subjected to the heating test is reduced by 1 mass % using a thermogravimetric/differential thermal analyzer (TG-DTA).

The fluororesin may be produced by a polymerization technique such as solution polymerization, bulk polymerization, emulsion polymerization, or suspension polymerization. In order to industrially easily produce the fluororesin, emulsion polymerization or suspension polymerization is preferred.

In the above polymerization, a polymerization initiator, a surfactant, a chain-transfer agent, and a solvent may be used, and each of these components may be conventionally known one.

The polymerization initiator may be an oil-soluble radical polymerization initiator or a water-soluble radical polymerization initiator.

The oil-soluble radical polymerization initiator may be a known oil-soluble peroxide. Typical examples thereof include dialkyl peroxycarbonates such as diisopropyl peroxydicarbonate, di-n-propyl peroxydicarbonate, and di-sec-butyl peroxydicarbonate; peroxy esters such as t-butyl peroxyisobutyrate and t-butyl peroxypivalate; and dialkyl peroxides such as di-t-butyl peroxide, as well as di[perfluoro (or fluorochloro) acyl] peroxides such as di(ω-hydro-dodecafluoroheptanoyl)peroxide, di(ω-hydro-tetradecafluoroheptanoyl)peroxide, di(ω-hydro-hexadecafluorononanoyl)peroxide, di(perfluorobutyryl)peroxide, di(perfluorovaleryl)peroxide, di(perfluorohexanoyl)peroxide, di(perfluoroheptanoyl)peroxide, di(perfluorooctanoyl)peroxide, di(perfluorononanoyl)peroxide, di(ω-chloro-hexafluorobutyryl)peroxide, di(ω-chloro-decafluorohexanoyl)peroxide, di(ω-chloro-tetradecafluorooctanoyl)peroxide, ω-hydro-dodecafluoroheptanoyl-ω-hydrohexadecafluorononanoyl-peroxide, ω-chloro-hexafluorobutyryl-ω-chloro-decafluorohexanoyl-peroxide, ω-hydrododecafluoroheptanoyl-perfluorobutyryl-peroxide, di(dichloropentafluorobutanoyl)peroxide, di(trichlorooctafluorohexanoyl)peroxide, di(tetrachloroundecafluorooctanoyl)peroxide, di(pentachlorotetradecafluorodecanoyl)peroxide, and di(undecachlorodotoriacontafluorodocosanoyl)peroxide.

The water-soluble radical polymerization initiator may be a known water-soluble peroxide, and examples thereof include ammonium salts, potassium salts, and sodium salts of persulfuric acid, perboric acid, perchloric acid, perphosphoric acid, and percarbonic acid, t-butyl permaleate, and t-butyl hydroperoxide. A reducing agent such as a sulfite or a sulfurous acid salt may be used in combination with a peroxide, and the amount thereof may be 0.1 to 20 times the amount of the peroxide.

The surfactant may be a known surfactant, and examples thereof include nonionic surfactants, anionic surfactants, and cationic surfactants. Preferred are anionic fluorosurfactants, and more preferred are C4-C20 linear or branched anionic fluorosurfactants optionally containing an ether-bond oxygen (in other words, an oxygen atom may be present between carbon atoms). The amount thereof (relative to the water as a polymerization medium) is preferably 50 to 5000 ppm.

Examples of the chain-transfer agent include hydrocarbons such as ethane, isopentane, n-hexane, and cyclohexane; aromatic substances such as toluene and xylene; ketones such as acetone; acetates such as ethyl acetate and butyl acetate; alcohols such as methanol and ethanol; mercaptans such as methyl mercaptan; and halogenated hydrocarbons such as carbon tetrachloride, chloroform, methylene chloride, and methyl chloride. The amount thereof may vary in accordance with the chain transfer constant of the compound used, and is typically 0.01 to 20 mass % relative to the polymerization solvent.

Examples of the solvent include water and solvent mixtures of water and an alcohol.

In the suspension polymerization, a fluorosolvent may be used in addition to water. Examples of the fluorosolvent include hydrochlorofluoroalkanes such as CH₃CClF₂, CH₃CCl₂F, CF₃CF₂CCl₂H, and CF₂ClCF₂CFHCl; chlorofluoroalkanes such as CF₂ClCFClCF₂CF₃ and CF₃CFClCFClCF₃; and perfluoroalkanes such as perfluorocyclobutane, CF₃CF₂CF₂CF₃, CF₃CF₂CF₂CF₂CF₃, and CF₃CF₂CF₂CF₂CF₂CF₃. Perfluoroalkanes are preferred. From the viewpoints of the suspension performance and economic efficiency, the amount of the fluorosolvent is preferably 10 to 100 mass % relative to the aqueous medium.

The polymerization temperature may be, but is not limited to, 0° C. to 100° C. The polymerization pressure is appropriately set in accordance with other polymerization conditions such as the type, amount, and vapor pressure of a solvent used, and the polymerization temperature. It may typically be 0 to 9.8 MPaG.

(B) Layer Formed from Polyamide Resin

The polyamide resin is a polymer containing an amide bond (—NH—C(═O)—) as a repeating unit in the molecule.

The polyamide resin may be either a polymer in which an amide bond in the molecule is coupled with an aliphatic structure or an alicyclic structure, what is called nylon, or a polymer in which an amide bond in the molecule is coupled with an aromatic structure, what is called aramid.

Examples of the nylon include, but are not limited to, nylon 6, nylon 66, nylon 11, nylon 12, nylon 610, nylon 612, nylon 6/66, nylon 66/12, nylon 1010, nylon 46, nylon 6T, nylon 9T, nylon 10T, and those formed from polymers such as meta-xylylenediamine/adipic acid copolymers. Two or more of these may be used in combination.

Examples of the aramid include, but are not limited to, polyparaphenylene terephthalamide and polymetaphenylene isophthalamide.

The polyamide resin is preferably at least one selected from the group consisting of nylon 6, nylon 66, nylon 11, nylon 12, nylon 610, nylon 612, nylon 6T, nylon 9T, nylon 6/66, nylon 66/12, and nylon 1010, more preferably at least one selected from the group consisting of nylon 610, nylon 612, nylon 1010, nylon 6, and nylon 66. Two or more of these may be used in combination.

The polyamide resin preferably has a melting point of 130° C. or higher. The polyamide with a melting point of lower than 130° C. may unfortunately melt in the use environment. The melting point of the polyamide resin is more preferably 150° C. or higher, still more preferably 180° C. or higher, particularly preferably 200° C. or higher.

The upper limit of the melting point may be any value. From the viewpoint of the adhesiveness between the layer (A) and the layer (B), for example, the melting point of the polyamide resin is preferably 260° C. or lower, more preferably 240° C. or lower. The melting point herein refers to a value determined using a differential scanning calorimeter (DSC).

The polyamide resin may have any weight average molecular weight, and the weight average molecular weight thereof is preferably 1000 to 1000000, for example. The weight average molecular weight is more preferably 5000 to 500000, still more preferably 10000 to 300000.

The weight average molecular weight refers to a value determined by gel permeation chromatography.

The respective layers constituting the laminate of the invention may contain any of polymers such as polyethylene, polypropylene, polyester, and polyurethane, inorganic fillers such as calcium carbonate, talc, celite, clay, titanium oxide, carbon black, and barium sulfate, and additives such as pigments, flame retardants, lubricants, photostabilizers, weather-resistance stabilizers, antistatics, ultraviolet absorbers, antioxidants, release agents, blowing agents, flavors, oils, and softening agents in amounts that do not affect the effects of the invention.

The laminate of the invention, which includes the layer (A) formed from a fluororesin and the layer (B) formed from a polyamide resin, can have moderate hardness and high elastic modulus retention even at high temperature. Therefore, the laminate can be used without flexure even at high temperature. Further, the laminate also has excellent fuel resistance and low fuel permeability.

In the laminate of the invention, the thickness of the layer (A) may be 0.01 to 2.0 mm, and is preferably 0.05 to 1.0 mm, while the thickness of the layer (B) may be 0.1 to 4.0 mm, and is preferably 0.2 to 2.0 mm.

Since the laminate of the invention includes the layer (B) formed from a polyamide resin, it can have moderate hardness even when the layer (A) is thin as described above.

The laminate may have any structure, such as a bilayer structure of the layer (A) and the layer (B), a trilayer structure of the same or different two layers (B) and the layer (A) disposed therebetween, or a trilayer structure of the same or different two layers (A) and the layer (B) disposed therebetween. Particularly preferred among these is a structure of layer (A)/layer (B)/layer (A) in which the fluororesin layers are disposed as an inner layer and an outer layer. The laminate of the invention may further include a layer of any suitable material.

The laminate of the invention may be produced by any method. The laminate may be produced by forming the respective layers separately and then stacking and bonding the layers, or may be produced by forming one layer and then forming another (or the other) layer thereon.

For example, the laminate may be produced by separately forming the layer (A) and the layer (B), and then stacking and bonding the layers by hot press, or may be produced by forming one layer, and then melt-extruding the other layer thereon, or may be simultaneously produced by forming and stacking the layers by co-extrusion.

The hot press and extrusion are preferably performed by any known methods as appropriate in accordance with the materials to be used.

Also, a stacking structure of three or more layers can be produced by co-extrusion molding, for example.

For example, the laminate can be produced by (1) co-extrusion-molding the layers constituting the laminate in a molten state and hot-melt-bonding (fusion-bonding) the interfaces of the layers in a single step (co-extrusion molding), (2) separately preparing the layers with an extruder and then stacking the layers and hot-melting the interfaces of the layers, (3) preparing a first layer in advance and then extruding a molten resin through an extruder on the surface of the first layer, or (4) preparing a first layer in advance, electrostatically applying a polymer to constitute a layer adjacent to the first layer on the surface of the first layer, and then heating the applied polymer as a whole or from the application side to heat-melt the polymer and form a layer.

In order to firmly bonding the layer (A) and the layer (B), co-extrusion molding is preferred.

In the co-extrusion molding, the resins for forming the respective layers are kneaded and molten in two or more different extruders each provided with a screw, and the molten resins are discharged from ejection ports. These molten resins are brought into contact with each other in a molten state while extruded through the corresponding die attached to the tip of the extruder. Thereby, the laminate is molded.

In the co-extrusion molding, the cylinder temperature is preferably 150° C. to 400° C. and the die temperature is more preferably 200° C. to 400° C. The number of rotations of the screws may be set as appropriate, and is preferably 5 to 200 rpm. The residence time of each molten resin in the extruder is preferably 1 to 20 minutes.

For the adhesiveness between the fluororesin layer (A) and the polyamide resin layer (B), the laminate of the invention preferably has a peel strength between the layers of 1 N/cm or higher, more preferably 2 N/cm or higher.

The peel strength refers to a value determined as a bond strength between the layers which corresponds to an average of five local maxima on the elongation-tensile strength graph obtained by 180° peeling test at 25 mm/min using a 1-cm-wide test piece from a tube and a TENSILON universal testing machine.

The laminate of the invention can suitably be used for biodiesel fuel which is used in a high-temperature environment. The biodiesel fuel refers to a fuel containing FAME obtained by transesterifying vegetable oil with methanol and decomposing and removing glycerin. Examples of FAME include fatty acid methyl ester mixtures including unsaturated fatty acid methyl esters, such as RME derived from rapeseed oil, SME derived from soybean, SFME derived from sunflower oil, PME derived from palm oil, and JME derived from Jatropha oil.

The laminate of the invention may be in any form, such as a film, a sheet, a tube, a hose, a bottle, or a tank. The film, the sheet, the tube, and the hose may have a corrugated or convoluted shape.

A molded article formed from the laminate is also one aspect of the invention. The molded article of the invention has high elastic modulus retention even at high temperature. The molded article also has excellent fuel barrier performance, as well as good mechanical strength, chemical resistance, oil resistance, heat resistance, and flexibility.

The laminate of the invention is a laminate having chemical resistance, oil resistance, heat resistance, and cold resistance, and is useful for components used in fuel piping systems, for example, such as a fuel tube and a fuel tank. The laminate is particularly useful for multilayer fuel tubes or multilayer fuel tanks of automobile engines and peripheral parts thereof, AT devices, and fuel systems and peripheral parts thereof. Examples of the uses of the laminate include fuel tubes for automobiles such as filler hoses, evaporator hoses, and breather hoses; in-tank tubes intended to be disposed inside a fuel tank; and fuel tanks such as fuel tanks for automobiles, fuel tanks for motorcycles, fuel tanks for small generators, and fuel tanks for lawn mowers.

The laminate may also be used for sealants such as gaskets and non-contact or contact packings (self-seal packings, piston rings, split ring packings, mechanical seals, and oil seals) requiring heat resistance, oil resistance, fuel oil resistance, LLC resistance, and steam resistance, for a variety of systems and components such as engine bodies, main drive systems, valve train systems, lubrication and cooling systems, fuel systems, and intake and exhaust systems of automobile engines; transmission systems of driveline systems; steering systems of chassis; braking systems; and electrical parts (e.g., basic electrical parts, electrical parts of control systems, and electrical accessories).

Examples of sealants used for engine bodies of automobile engines include, but are not limited to, gaskets, O-rings, packings, and timing belt cover gaskets such as cylinder head gaskets, cylinder head cover gaskets, sump packings, and general gaskets.

Examples of sealants used for main drive systems of automobile engines include, but are not limited to, shaft seals such as crankshaft seals and camshaft seals.

Examples of the sealants used for valve train systems of automobile engines include, but are not limited to, valve stem oil seals for engine valves.

The laminate may also be applied to uses other than the automobile-related uses, such as, but not limited to,

films and sheets: films and sheets for food, films and sheets for chemicals, and diaphragms and packings for diaphragm pumps,

tubes and hoses: tubes and hoses for solvents, tubes and hoses for coatings, radiator hoses, air conditioner hoses, and brake hoses of automobiles, electric wire coating materials, tubes and hoses for food and beverage, underground tubes and hoses for gas stations, and tubes and hoses for submarine oil fields,

bottles, containers, and tanks: tanks for solvents, tanks for coatings, tanks for chemicals such as tanks for chemicals for semiconductors, and tanks for food and beverage, and

others: machine-related seals and gears such as seals of oil hydraulic components.

The laminate is particularly favorably used as a tube or a hose among these.

The tube or hose may have a wave-patterned region at any part thereof. The wave-patterned region herein means any part of the tube or hose in a shape such as a wave-patterned shape, a corrugated shape, or a convoluted shape.

When the tube or hose has such a region where multiple folds are disposed in a wave pattern in a circular shape, it is compressed at one portion of the circular shape while it is extended at another portion of the circular shape within the region, so that the tube or hose can be easily bent at any angle without stress fatigue or delamination.

The waveform region may be formed by any method. For example, it can easily be formed by preparing a linear tube and then giving a predetermined shape such as a wave shape to the tube by in-mold decoration.

The laminate of the invention is favorably applied to uses such as fuel hoses (tubes) and tanks which have a portion to be in contact with fuel during the use.

A fuel hose formed from the laminate is also one aspect of the invention. Since the laminate of the invention has high elastic modulus retention even at high temperature as described above, it is suitable for uses requiring high-temperature resistance, such as fuel piping, and thus can be favorably used as a laminate for fuel hoses to be used as tubes of automobile fuel piping. In this case, a portion to be in contact with fuel is preferably constituted by the layer (A). In other words, the innermost layer preferably corresponds to the layer (A).

The innermost layer of a fuel hose is in contact with flammable liquid such as gasoline to easily accumulate static electricity. In order to avoid ignition due to this static electricity, the innermost layer preferably contains a conductive filler.

Examples of the conductive filler include, but are not limited to, powder or fiber of a conductive simple substance such as metal or carbon; powder of a conductive compound such as zinc oxide; and powder with a surface having undergone a conductivity-imparting treatment.

Examples of the powder or fiber of a conductive simple substance include, but are not limited to, powder of metal such as copper or nickel; fiber of metal such as iron or stainless steel; and carbon materials such as carbon black, carbon nanotube, carbon fiber, and carbon fibril described in JP H03-174018 A.

The powder with a surface having undergone a conductivity-imparting treatment is a powder obtainable by subjecting the surface of non-conductive powder such as glass beads or titanium oxide powder to a conductivity-imparting treatment. Examples of the conductivity-imparting treatment include, but are not limited to, metal sputtering and electroless plating. Preferred among the above conductive fillers is carbon black because it is advantageous in terms of economic efficiency and prevention of static electricity accumulation.

An in-tank tube formed from the laminate of the invention (the first in-tank tube of the invention) is also one aspect of the invention.

Common fuel piping systems of automobiles have a mechanism in which fuel (e.g., gasoline) required to start an engine is sucked and supplied from a fuel tank. Such suction of fuel is performed by a pump disposed inside the fuel tank, and the hose coupled with this fuel pump in the fuel tank is referred to as an in-tank tube.

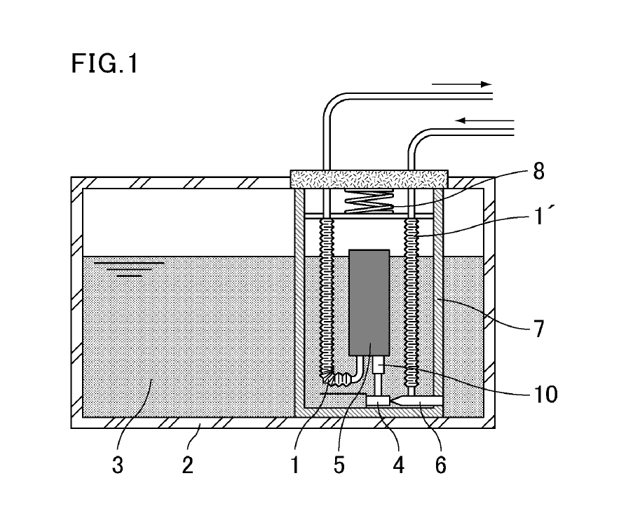

The in-tank tube is disposed inside a fuel tank. For example, FIG. 1 is a schematic view of the inside of a fuel tank of an automobile. An in-tank tube 1 and a fuel pump 5 are typically coupled via a connector 10. An injection portion of the connector 10 is injected into an end portion of the in-tank tube 1 to be coupled with the in-tank tube 1, while a fitting portion of the connector is fitted with a fitting portion of the fuel pump 5 to be coupled with the fuel pump 5. Since the in-tank tube is disposed inside the fuel tank, it needs to have better high-temperature resistance. The in-tank tube also needs to have moderate hardness.

The laminate of the invention has moderate hardness as well as high elastic modulus retention even at high temperature, and thus is especially suitable for in-tank tubes.

For the first in-tank tube of the invention, the inner diameter thereof is typically set to 5 to 20 mm, preferably 6 to 15 mm. The thickness of the wall is set to 0.5 to 5 mm, preferably 0.7 to 3 mm.

The second in-tank tube of the invention includes a layer (A′) formed from a fluororesin, and the fluororesin is a copolymer containing a polymerized unit based on tetrafluoroethylene and a polymerized unit based on vinylidene fluoride.

The in-tank tubes are required to have high elastic modulus retention even at high temperature and have moderate hardness. Here, the second in-tank tube of the invention includes a layer formed from the above specific fluororesin, so that it has high elastic modulus retention even at high temperature and has moderate hardness.

The second in-tank tube of the invention is typically disposed inside a fuel tank.

The fluororesin for the layer (A′) may favorably be the same as the fluororesin constituting the fluororesin layer (A) of the laminate of the invention.

The second in-tank tube of the invention may have a monolayer structure consisting only of the layer (A′) formed from a fluororesin, or may have a structure of two or more layers including a layer of any material stacked on the layer (A′).

In terms of the elastic modulus retention at high temperature, the monolayer structure is preferred. In other words, it is one preferred embodiment of the invention that the in-tank tube consists only of the layer (A′) formed from a fluororesin.

In terms of the cost, a structure of two or more layers is preferred. For example, preferred is a laminate including the layer (A′) and a layer of at least one resin selected from the group consisting of polyamide resin and polyethylene resin.

In terms of the hardness, the second in-tank tube is preferably a laminate with the layer (B) that is described for the laminate of the invention.

When the second in-tank tube of the invention has a structure of two or more layers, examples of the structure include a bilayer of the layer (A′) and the layer (B), a trilayer of the same or different two layers (B) and the layer (A′) disposed therebetween, and a trilayer of the same or different two layers (A′) and the layer (B) disposed therebetween.

For the second in-tank tube of the invention, the inner diameter thereof is typically set to 5 to 20 mm, preferably 6 to 15 mm. The thickness of the wall is set to 0.5 to 5 mm, preferably 0.7 to 3 mm. For the second in-tank tube of the invention having a monolayer structure, the thickness of the layer (A′) is the same as the above wall thickness. Still, in terms of the hardness, the thickness of the layer (A′) is preferably 0.8 mm or greater, more preferably 0.9 mm or greater.

For the second in-tank tube of the invention having a structure of two or more layers, the thickness of the layer (A′) is preferably 0.01 to 4 mm, more preferably 0.03 to 2 mm.

The second in-tank tube of the invention can be produced by extrusion molding using an extruder, for example. A structure of two or more layers can be produced by the same method as described for the laminate of the invention.

The second in-tank tube of the invention can suitably be used for biodiesel fuel which is used in a high-temperature environment. The biodiesel fuel refers to a fuel containing FAME obtained by transesterifying vegetable oil with methanol and decomposing and removing glycerin. Examples of FAME include fatty acid methyl ester mixtures including unsaturated fatty acid methyl esters, such as RME derived from rapeseed oil, SME derived from soybean, SFME derived from sunflower oil, PME derived from palm oil, and JME derived from jatropha oil.

### EXAMPLES

The invention will be described in more detail below referring to examples. The parameters in the examples were determined by the following methods.

### Monomer Composition of Fluororesin

The monomer composition of the fluororesin was determined by ¹⁹F-NMR at a measurement temperature of the melting point of the polymer+20° C. using a nuclear magnetic resonance device AC300 (Bruker-Biospin), appropriately in combination with elemental analysis in accordance with the integral value of the peaks and the types of the monomers.

### Melting Point

The melting point was determined from the peak on an endothermic curve obtained by thermal analysis at a temperature-increasing rate of 10° C./min using a differential scanning calorimeter RDC220 (Seiko Instruments Inc.) in conformity with ASTM D-4591.

### Melt Flow Rate (MFR)

The MFR was defined as the mass (g/10 min) of a polymer flowing out of a nozzle (inner diameter: 2 mm, length: 8 mm) per 10 minutes at 297° C. and a 5-kg load using a melt indexer (Toyo Seiki Seisaku-sho, Ltd.) in conformity with ASTM D3307-01.

Pyrolysis Starting Temperature (Temperature at which Mass is Reduced by 1 Mass %)

The pyrolysis starting temperature was defined as the temperature at which the mass of the fluororesin subjected to the heating test was reduced by 1 mass % using a thermogravimetric/differential thermal analyzer (TG-DTA).

### Tensile Modulus

The tensile modulus was determined using a 2-mm-thick microdumbbell at a tensile rate of 100 mm/min in conformity with ASTM D1708. The resulting value is an average value with N=5.

### Storage Elastic Modulus (E′)

The storage elastic modulus was measured by dynamic mechanical analysis at 170° C. Specifically, it was measured using a dynamic viscoelasticity analyzer DVA220 (IT Keisoku Seigyo) and a sample having a size of 30 mm in length, 5 mm in width, and 0.25 mm in thickness in a tensile mode, at a grip width of 20 mm, a measurement temperature of 25° C. to 250° C., a temperature-increasing rate of 2° C./min, and a frequency of 1 Hz.

### Synthesis Example 1

A 3000-L autoclave was charged with 900 L of distilled water. The autoclave was sufficiently purged with nitrogen, and 674 kg of perfluorocyclobutane was put thereinto. The temperature inside the system and the stirring rate were respectively maintained at 35° C. and 200 rpm. Next, 207 g of CH₂=CHCF₂CF₂CF₂CF₂CF₂CF₃, 62.0 kg of tetrafluoroethylene (TFE), and 18.1 kg of vinylidene fluoride (VDF) were successively added, and then 2.24 kg of a 50 mass % methanol solution of di-n-propyl peroxydicarbonate (NPP) was added as a polymerization initiator. Thereby, polymerization was started. Simultaneously with the start of the polymerization, 2.24 kg of ethyl acetate was added. Since the pressure inside the system decreased as the polymerization proceeded, a TFE/VDF monomer gas mixture (TFE/VDF=60.2/39.8 (mol %)) was added, together with CH₂═CHCF₂CF₂CF₂CF₂CF₂CF₃ in an amount of 1.21 parts for each 100 parts of the gas mixture added. Thereby, the pressure inside the system was maintained at 0.8 MPa. The polymerization was stopped when the amount of the monomer gas mixture added to the system reached 110 kg, and the pressure was released to atmospheric pressure. Then, the resulting TFE/VDF/CH₂═CHCF₂CF₂CF₂CF₂CF₂CF₃ copolymer (Fluororesin 1) was brought into contact with 0.8 mass % ammonia water at 80° C. for one hour, washed with water, and dried. Thereby, 102 kg of powder was obtained.

Next, the powder was melt-extruded into pellets through a ϕ50-mm single-screw extruder at a cylinder temperature of 290° C. The resulting pellets were then heated and deaerated at 170° C. for 10 hours.

The resulting pellets had the following composition and physical properties.

TFE/VDF/CH₂═CHCF₂CF₂CF₂CF₂CF₂CF₃=60.1/39.6/0.3 (mol %)
Melting point: 218° C.
MFR: 1.7 g/10 min (297° C. and 5 kg)
Pyrolysis starting temperature (temperature at which mass is reduced by 1 mass %): 388° C.
Tensile modulus: 421 MPa (room temperature), 133 MPa (100° C.), 111 MPa (150° C.)
Storage elastic modulus (E′): 130 MPa

### Reference Example 1

The tensile moduli of a fluororesin (PVDF, Solef 60512, SOLVAY SOLEXIS) were measured by the above method. The results of the measurement are shown in the following Table 1 together with the results of Fluororesin 1.

TABLE 1

| | Temperature (° C.) | 25 | 100 | 150 |
|---|---|---|---|---|
| Fluororesin 1 | Tensile modulus (MPa) | 421 | 133 | 111 |
| | Retention (%) vs. standard | 100 | 32 | 26 |
| | value at room temperature | | | |
| Solef 60512 | Tensile modulus (MPa) | 790 | 205 | 70 |
| | Retention (%) vs. standard | 100 | 26 | 9 |
| | value at room temperature | | | |

### Example 1

An extruding apparatus for a four-material four-layer tube provided with a multi-manifold die was prepared, and nylon 610 (Daicel-Evonik Ltd., melting point: 215° C.) was fed to outer-layer and outermost-layer extruders, while Fluororesin 1 produced by the polymerization in Synthesis Example 1 was fed to inner-layer and innermost-layer extruders to provide a bilayer tube having an outer diameter of 8 mm and an inner diameter of 6 mm. The die temperature of the extruding apparatus was set to 280° C., and the tube take-up speed was set to 8.0 m/min. The thickness of the inner layer fluororesin was set to 0.5 mm and the thickness of the outer layer polyamide resin (nylon 610) was set to 0.5 mm. The bond strength was 2.5 N/cm. The resulting tube was mounted on a fuel pump and exposed to a pressure of 1 MPa at 130° C. This caused no leakage of fuel through the tube coupling portion.

### Example 2

Fluororesin 1 produced by the polymerization in Synthesis Example 1 was fed to a monolayer tube extruder, and a monolayer tube having an outer diameter of 8 mm, an inner diameter of 6 mm, a layer thickness of 1 mm was formed. The die temperature of the extruder was set to 280° C., and the tube take-up speed was set to 8.0 m/min. The resulting tube was mounted on a fuel pump and exposed to a pressure of 1 MPa at 130° C. This caused no leakage of fuel through the tube coupling portion.

### Comparative Example 1

An extruding apparatus for a four-material four-layer tube provided with a multi-manifold die was prepared, and the above nylon 610 was fed to outer-layer and outermost-layer extruders, while a fluororesin (PVDF, Solef 60512) was fed to inner-layer and innermost-layer extruders to provide a tube having an outer diameter of 8 mm and an inner diameter of 6 mm. The die temperature of the extruding apparatus was set to 250° C., and the tube take-up speed was set to 8.0 m/min. The thickness of the inner layer fluororesin was set to 0.5 mm and the thickness of the outer layer polyamide resin (nylon 610) was set to 0.5 mm. The bond strength was not higher than 1 N/cm. The resulting tube was mounted on a fuel pump and exposed to a pressure of 1 MPa at 130° C. This caused leakage of fuel through the tube coupling portion, and thus the tube was unfit for use.

### INDUSTRIAL APPLICABILITY

The laminate of the invention has high elastic modulus retention even at high temperature. Thus, the laminate is useful for fuel peripheral components such as fuel piping systems of automobiles, and can suitably be used for components such as in-tank tubes.

### REFERENCE SIGNS LIST

1, 1′: in-tank tube
2: fuel tank
3: fuel
4: filter
5: fuel pump
6: jet pump
7: housing
8: spring
10: connector

1. A laminate comprising:
a layer (A) formed from a fluororesin; and
a layer (B) formed from a polyamide resin,
the fluororesin being a copolymer containing a copolymerized unit of tetrafluoroethylene and a copolymerized unit of vinylidene fluoride, and having a storage elastic modulus (E′) of 60 to 400 MPa measured by dynamic mechanical analysis at 170° C.

2. The laminate according to claim 1,
wherein the fluororesin is a copolymer containing a copolymerized unit of tetrafluoroethylene, a copolymerized unit of vinylidene fluoride, and a copolymerized unit of an ethylenically unsaturated monomer represented by the following formula (1), excluding tetrafluoroethylene and vinylidene fluoride, and/or a copolymerized unit of an ethylenically unsaturated monomer represented by the following formula (2),
the formula (1) being CX¹X²═CX³(CF₂)ₙX⁴
wherein X¹, X², X³, and X⁴ are the same as or different from each other, and are each H, F, or Cl; and n is an integer of 0 to 8,
the formula (2) being CF₂═CF—ORf¹
wherein Rf¹ is a C1-C3 alkyl or fluoroalkyl group.

3. The laminate according to claim 1,
wherein the polyamide resin has a melting point of 200° C. or higher.

4. A molded article comprising the laminate according to claim 1.

5. An in-tank tube comprising the laminate according to claim 1.

6. The in-tank tube according to claim 5,
wherein the in-tank tube is intended to be disposed inside a fuel tank.

7. An in-tank tube comprising a layer (A′) formed from a fluororesin,
the fluororesin being a copolymer containing a polymerized unit based on tetrafluoroethylene and a polymerized unit based on vinylidene fluoride, and having a storage elastic modulus (E′) of 60 to 400 MPa measured by dynamic mechanical analysis at 170° C.

8. The in-tank tube according to claim 7, consisting only of the fluororesin layer (A′).

9. The in-tank tube according to claim 7,
wherein the fluororesin is a copolymer containing a copolymerized unit of tetrafluoroethylene, a copolymerized unit of vinylidene fluoride, and a copolymerized unit of an ethylenically unsaturated monomer represented by the formula (1), excluding tetrafluoroethylene and vinylidene fluoride, and/or a copolymerized unit of an ethylenically unsaturated monomer represented by the formula (2),
the formula (1) being CX¹X²═CX³(CF₂)ₙX⁴
wherein X¹, X², X³, and X⁴ are the same as or different from each other, and are each H, F, or Cl; and n is an integer of 0 to 8,
the formula (2) being CF₂═CF—ORf¹
wherein Rf¹ is a C1-C3 alkyl or fluoroalkyl group.

10. The in-tank tube according to claim 7,
wherein the fluororesin has a tensile modulus at 150° C. that corresponds to 15% or more of the tensile modulus at room temperature.

11. The in-tank tube according to claim 7,
wherein the in-tank tube is intended to be disposed inside a fuel tank.
